(19) United States
(12) Patent Application Publication
(10) Pub. No.: US 2015/0051977 A1
(43) Pub. Date: Feb. 19, 2015

(54) CREDIT PREAUTHORIZATION ON USER DEVICE DETECTION SYSTEMS AND METHODS

(71) Applicants: Nate Lee Lyman, San Jose, CA (US); Roy Leon Camp, San Jose, CA (US); Eric John Farraro, San Jose, CA (US); John Richard Tapley, San Jose, CA (US)

(72) Inventors: Nate Lee Lyman, San Jose, CA (US); Roy Leon Camp, San Jose, CA (US); Eric John Farraro, San Jose, CA (US); John Richard Tapley, San Jose, CA (US)

(21) Appl. No.: 13/967,739

(22) Filed: Aug. 15, 2013

(51) Int. Cl. G06Q 30/02

(52) U.S. Cl. CPC G06Q 30/0261; G06Q 40/025
USPC 705/14.58

(57) ABSTRACT

There is provided systems and method for credit preauthorization on user device detection. The methods include receiving merchant information and user information, wherein the user information is received after a user device corresponding to the user information is determined to be in a geographic area corresponding to the merchant information, determining a credit preauthorization amount based on the user information, and transmitting the credit preauthorization amount to a merchant device corresponding to the merchant information.

### BACKGROUND

1. Technical Field

The present application generally relates to credit preauthorization on user device detection and more specifically to detecting a user device in proximity to a merchant and extending a preauthorized credit amount to the user.

2. Related Art

Today, consumers bring mobile devices with them as they engage in daily activities. These consumers may utilize applications on their mobile devices that enable each individual consumer to “check-in,” or identify their location and broadcast it to other consumers, merchants, devices, websites, and other interested parties. This may enable the consumer and others to locate merchants, friends, and potentially desirable places. Additionally, merchants may be able to track consumers in order to offer sales, coupons, or other advertising and marketing techniques in order to entice consumers to visit or return to their establishment. However, consumers may not have sufficient funds when at a merchant to purchase goods and/or services, and thus may miss desirable sales. Thus, both the consumer and the merchant may not engage in an otherwise favorable transaction.

### BRIEF DESCRIPTION OF THE DRAWINGS

FIG. 1 is a block diagram of a networked system suitable for implementing the process described herein according to an embodiment;

FIG. 2 is an exemplary credit preauthorization interaction on detection of a user device at a merchant according to an embodiment;

FIG. 3 is a flowchart of an exemplary process by a payment provider server for providing credit preauthorization on user device detection according to an embodiment; and

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In certain embodiments, a user may bring a mobile device with them as the user engages in daily activities at vendors, such as shopping, eating, and other potential vendor activities. The user device may include a check in application, where the user can utilize either a GPS locator of the user device and/or a wireless connection to determine a location of the user, and “check-in” or otherwise identify the user with that location. In various embodiments, the location corresponds to the vendor where the user is currently located. In some embodiments, the vendor may receive user information through a wireless connection, such as a wireless Internet connect, near field communication, Bluetooth, Bluetooth Low Energy, radio, infrared, or other connection. After receiving the information for the user and/or user device, the merchant may utilize the information to request a credit preauthorization amount from a credit provider, such as a payment service provider. For example, the merchant may request a credit amount for a “Bill Me Later” option of a credit provider. In other embodiments, user information and merchant information may be transmitted to the credit provider from a third party or directly from the user device. Once the merchant receives an amount for a credit preauthorization, the merchant may further target specific advertisements, sale offers, merchandise, or other marketing to the user based on the user's available credit.

In some embodiments, a user may set up an account with a payment service provider or other credit provider. The credit provider may include information corresponding to the user's credit score, available assets, or other information relevant to extending credit amounts to the user. Additionally, a user device may include information identifying the user with the account. For example, the user may install a payment application or other financial application on the user device possessing login information, cookies, or other identifiers corresponding to the account. The user device may include user information capable of matching the user device with the account. However, in other embodiments, the user may not set up an account with a credit provider and, therefore, the credit provider may be chosen by the merchant store or at random.

Thus, a user may travel to a merchant store of the user's preference during a shopping trip with a user device. When the user arrives at the store, the user may “check-in,” or identify the user's location with the store. The user may check-in using an application through a wireless Internet connection with an application management server corresponding to the check-in application. However, in other embodiments, the user device may check-in with the merchant store itself using a connection with the merchant store, such as using near field communication, Bluetooth, Bluetooth Low Energy, radio, infrared, or other connection. Once the user has checked-in, the credit provider may receive information identifying the merchant store and the user. The credit provider may determine a credit amount to extend to the user based on the information, such as user personal information, a user account identifier, and a user device identifier. The credit provider may then transmit the credit amount back to the merchant store based on the merchant identifying information, and the merchant store may extend the credit with any merchant offered credit, and any corresponding sales offers or other incentives, to the user through the user device.

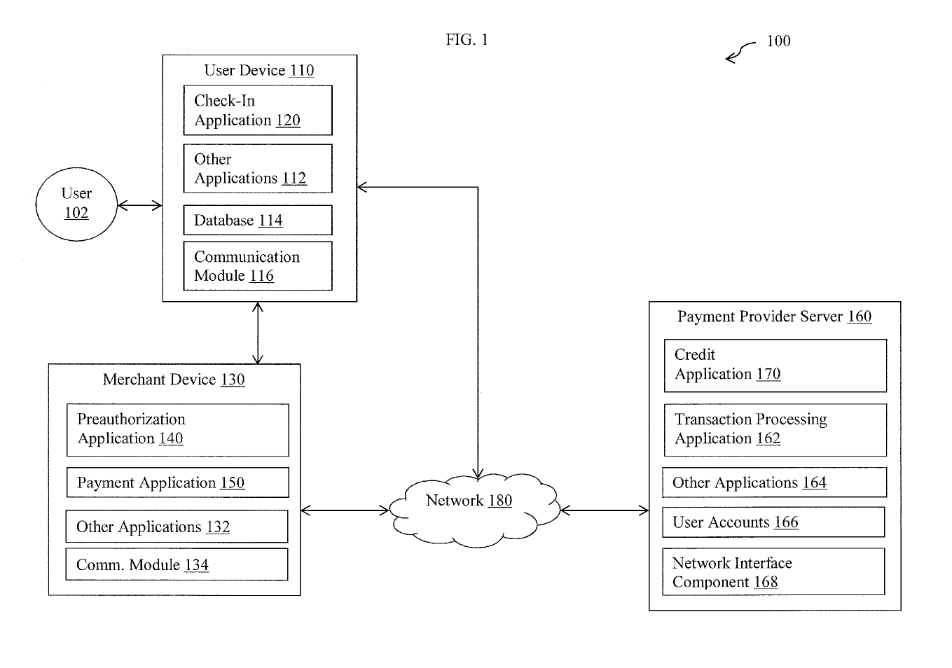

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant device 130, and a payment provider server 160 in communication over a network 180. User 102, such as a consumer, may utilize user device 110 while in a geographic area corresponding to merchant device 130, such as a retail store. In certain embodiments, payment provider server 160 may receive information identifying user 102 and merchant device 130, determine a credit preauthorization amount corresponding to user 102, and transmit the credit preauthorization amount to merchant device 130.

User device 110, merchant device 130, and payment provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

User device 110 may be implemented using any appropriate hardware and software configured for wired and/or wireless communication with merchant device 130 and/or payment provider server 160 over network 180. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 120, other applications 112, a database 114, and a network interface component 116. Check-in application 120 and other applications 112 may correspond to processes, procedures, and/or applications executable by a hardware processor, for example, a software program. In other embodiments, user device 110 may include additional or different software as required.

In various embodiments, check-in application 120 may be used by user 102 of user device 110 to identify user 102 with a location. For example, check-in application 120 may utilize a GPS module of user device 110 to determine a location of user device 110. Check-in application 120 may transmit that location to an application management server corresponding to check-in application 120 using a wireless Internet connection. For example, in some embodiments, check-in application 120 may correspond to a social networking application, where a location of user 102 determined from user device 110 is transmitted to a corresponding social networking service. However, in other embodiments, check-in application 120 may be utilized to check-in to locations with a server without a social networking service, may be merchant specific, or may communicate with payment provider server 160. Once check-in application 120 has located user 102 as in a geographic area corresponding to a merchant, a credit provider, such as payment provider server 160, may receive user information, such as user personal information, a user account identifier, and a user device identifier, and merchant information. Additionally, check-in application may be configured to communicate with a merchant device, for example, to receive messages from the merchant, such as a credit preauthorization amount, advertisement, sale offer, or other message.

In certain embodiments, check-in application 112 may correspond to a specific application utilized by user device 110 with a merchant device, such as merchant device 130, to alert the merchant device that user device 110 is in proximity to the merchant device. In such embodiments, check-in application 120 of user device 110 may utilize short range wireless communication with the merchant device, such as near field communication, Bluetooth, Bluetooth Low Energy, radio, infrared, or other connection. Check-in application 120 may transmit user information, such as user personal information, a user account identifier, and a user device identifier. Once check-in application 120 has transmitted the user information to the merchant device, the merchant device may transmit the user information with merchant information to a credit provider, such as payment provider server 160. Check-in application 120 may correspond to an application available for download over network 180.

In various embodiments, user device 110 includes other applications 112 as may be desired in particular embodiments to provide desired features to user device 110. For example, other applications 112 may include security applications for implementing client-side security features, programmatic client applications for interfacing with appropriate application programming interfaces (APIs) over network 180, or other types of applications. Other applications 112 may also include email, texting, voice and IM applications that allow a user to send and receive emails, calls, texts, and other notifications through network 180. Other applications 112 may include financial applications, such as banking, online payments, money transfer, or other applications associated with payment provider server 160. Other applications 112 may contain software programs, such as a graphical user interface (GUI), executable by a processor that is configured to provide an interface to the user.

User device 110 may further include database 114 which may include, for example, identifiers such as operating system registry entries, cookies associated with check-in application 120 and/or other applications 112, identifiers associated with hardware of user device 110, or other appropriate identifiers, such as identifiers used for payment/user/device authentication or identification. In one embodiment, identifiers in database 114 may be used by a credit provider, such as payment provider server 160, to associate user device 110 with a particular account maintained by the credit provider.

Database 114 may further contain user information for transmission to a merchant device and/or credit provider server, or may include data to access user information. Thus, database 114 may contain further user personal information (e.g. a name, social security number, user financial information, or other identifying information), a user account identifier, and a user device identifier. In various embodiments, database 114 may include information to access user information including online account access information.

In various embodiments, user device 110 includes at least one communication module 116 adapted to communicate with merchant device 130 and/or payment provider server 160 over network 180. In various embodiments, communication module 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 130 may be maintained, for example, by a merchant or seller offering various items, products, and/or services through a merchant location. Generally, merchant device 130 may be maintained by anyone or any entity that receives money, which includes charities as well as retailers and restaurants. In this regard, merchant device 130 may include processing applications, which may be configured to interact with user device 110 and/or payment provider server 160 to facilitate the sale of products, goods, and/or services.

Merchant device 130 may be implemented using any appropriate hardware and software configured for wired and/or wireless communication with user device 110 and/or payment provider server 160. For example, in one embodiment, merchant device 130 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device. Although only one merchant device is shown, a plurality of merchant devices may be utilized.

Merchant server 130 includes a preauthorization application 140, a payment application 150, other applications 132, and a communication module 134. Preauthorization application 140, payment application 150, and other applications 132 may correspond to processes, procedures, and/or applications executable by a hardware processor, for example, a software program. In other embodiments, merchant device 130 may include additional or different software as required

Merchant device 130 includes preauthorization application 140, which may be configured to communicate information with user device 110 and/or payment provider server 160 over network 180. In various embodiments, preauthorization application 140 receives a credit preauthorization amount corresponding to user 102 from a credit provider and communicates the credit preauthorization amount to user device 110. Thus, preauthorization application 140 may communicate with user device 110 using short range wireless communication, such as Bluetooth, Bluetooth Low Energy, radio, infrared, or other connection.

In certain embodiments, preauthorization application 140 may also receive user information from user device 110 over a short range wireless communication with user device 110, such as Bluetooth, Bluetooth Low Energy, radio, infrared, or other connection. Preauthorization application 140 may request a credit preauthorization amount if merchant device 130 has not yet received one by transmitting the user information and merchant information to a credit provider, such as payment provider server 160. The merchant information may include information identifying the merchant and relevant information necessary to obtain a credit preauthorization amount from the credit provider. As previously discussed, user information may include as user personal information (e.g. a name, social security number, user financial information, or other identifying information), a user account identifier, and a user device identifier. Once merchant device 130 has received a response from the credit provider, preauthorization application 140 may transmit the response to user device 110.

Preauthorization application 140 may transmit additional information from merchant device 130 to user device 110, such as credit acceptance terms and merchant messages including advertisements and sale offers. In various embodiments, preauthorization application 140 may additionally receive communications from user device 110, such as user information, acceptance of the credit preauthorization amount, user selection of merchant goods, or other information.

Merchant device 130 includes a payment application 150 configured to provide a convenient interface to permit a salesperson to select, review, and sell items to user 102. For example, in one embodiment, payment application 150 may be implemented as an application having a user interface enabling the user to buy products available at a merchant corresponding to merchant device 130. Thus, payment application 150 may include an interface displaying user selected products for purchase, including product information, purchase price, and total purchase costs. In some embodiments, payment application 150 may correspond more generally to a web browser configured to view merchant information available over the Internet or access a website corresponding to products available from a merchant. Thus, payment application 150 may also be utilized to access merchant websites and engage in online transactions.

Payment application 150 may further include information corresponding to a payment method selected by user 102. For example, payment application 150 may include cash, check, credit card, credit preauthorization amount, or other payment method. Thus, if user 102 selects to pay using the credit preauthorization amount, payment application 150 may display the amount and engage in the proper steps of authorizing the credit amount and completing purchase of the products using the credit. Payment application 150 may communicate with a credit provider, such as payment provider server 160 over network 180 to authorize the credit amount extended to user 102, and receive payment from the credit provider.

In various embodiments, merchant device 130 includes other applications 132 as may be desired in particular embodiments to provide desired features for merchant device 130. For example, other applications 132 may include security applications for implementing server-side security features, programmatic server applications for interfacing with appropriate application programming interfaces (APIs) over network 150, or other types of applications. Other applications 132 may contain software programs, such as a graphical user interface (GUI), executable by a processor that is configured to provide an interface to the user.

In various embodiments, merchant device 130 includes at least one communication module 134 adapted to communicate with user device 110 and/or network 180 including payment provider server 160. In various embodiments, communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 160 may be maintained, for example, by an online payment service provider, which may provide credit services and/or processing for financial transactions on behalf of a user with a merchant. In this regard, payment provider server 160 includes one or more processing applications which may be configured to interact with user device 110 and/or merchant device 130 to facilitate credit preauthorization and/or payments. In one example, payment provider server 160 may be provided by PayPal®, Inc. of San Jose, Calif., USA. However, in other embodiments, payment provider server 160 may be maintained by or include a credit provider, financial services provider, financial data provider, and/or other service provider, which may provide credit preauthorization based on user and/or merchant information. Payment provider server 160 may additionally perform credit authorization and payment of goods with credit, for example, the exchange of goods between a merchant and user 102 based on credit extended to user 102.

Payment provider server 160 of FIG. 1 includes a credit application 170, a transaction processing application 162, other applications 164, user accounts 166, and a network interface component 168. Credit application 170, transaction processing application 162, and other applications 164 may correspond to processes, procedures, and/or applications executable by a hardware processor, for example, a software program. In other embodiments, payment provider server 160 may include additional or different software as required.

Credit application 170 of payment provider server 160 may be configured to communicate information with user device 110 and/or merchant device 130 over network 180. In various embodiments, credit application 170 receives user information corresponding to user 102 and merchant information corresponding to merchant device 130 (e.g. a merchant and merchant location), determines a credit preauthorization amount for user 102, and communicates the credit preauthorization amount to merchant device 130. Credit application 170 may receive the user information and/or merchant information from user device 110, merchant device 130, or both. Credit application 170 may transmit additional information with the credit preauthorization amount, such as credit card offers, credit terms, revolving credit options (e.g. a bill me later option), or other information.

Credit application 170 may determine a credit preauthorization amount based on user information, such as user personal information, a user account identifier, and a user device identifier. For example, credit application 170 may include user credit rating review processes, processes to determine user assets and debts, user purchase and payment history, or other processes necessary to determine an amount of credit to extend to user 102. In various embodiments, credit application 170 may access a user account stored on or external to payment provider 160 to determine the credit preauthorization amount, such as bank accounts, payment accounts, or other user accounts. Credit application 170 may receive an account identifier, or identify the account through the user of an identifier corresponding to user device 110 that has previously been associated with user 102.

Payment provider server 160 may include a transaction processing application 162, which may be configured interact with user device 110 and/or merchant device 130 over network 180 to facilitate payments to merchant device 130. In various embodiments, transaction processing application 162 includes features to receive a request to issue a payment and effectuate the payment to merchant device 130 for an item, for example using credit issued to user 102.

In various embodiments, payment provider server 160 includes other applications 164 as may be desired in particular embodiments to provide desired features to payment provider server 160. For example, other applications 164 may include security applications for implementing server-side security features, programmatic server applications for interfacing with appropriate application programming interfaces (APIs) over network 180, or other types of applications. Other applications 164 may contain software programs, such as a graphical user interface (GUI), executable by a processor that is configured to provide an interface to a user.

Additionally, payment provider server 160 may include user accounts 166. As previously discussed, user 102 may establish one or more user accounts with payment provider server 160. User accounts 166 may include user information, such as name, address, birthdate, payment/funding information, additional user financial information, and/or other desired user data. User 102 may link user accounts 164 to user device 110 through a user device identifier. Thus, when a device identifier corresponding to user device 110 is transmitted to payment provider server 160, e.g. from user device 110 or merchant device 130, a user account belonging to user 102 may be found. However, in other embodiments, user 102 may not have previously established a user account. Thus, payment provider server 160 may determine a credit preauthorization amount using different user information, such a name, social security number, user financial information, or other user information.

In various embodiments, payment provider server 160 includes at least one network interface component (NIC) 168 adapted to communicate with network 180 including user device 110 and merchant device 130. In various embodiments, network interface component 168 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

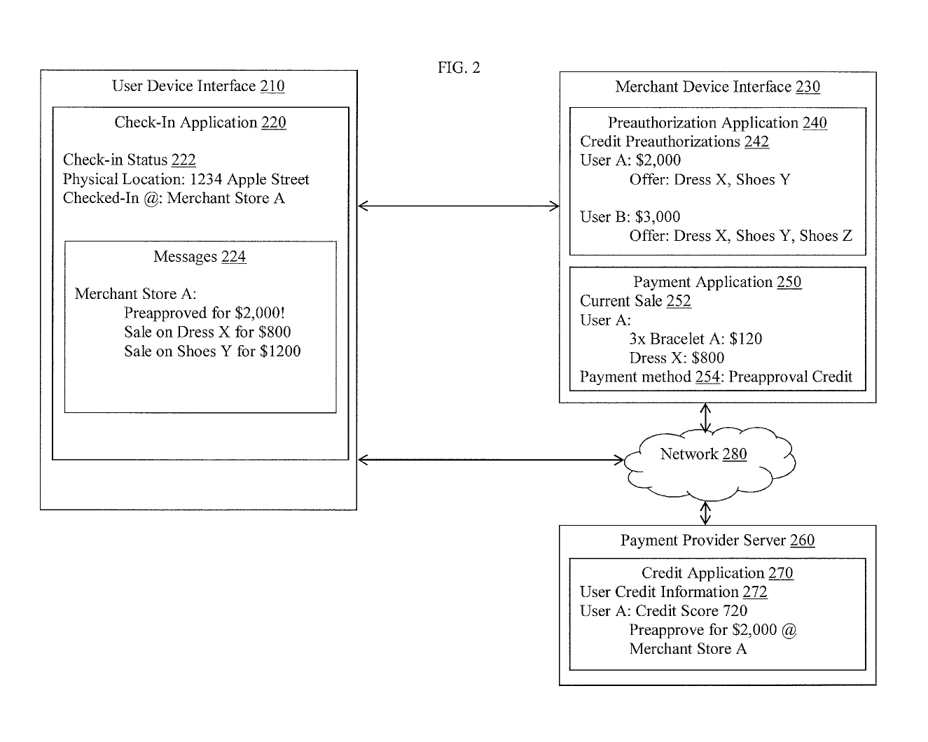

FIG. 2 is an exemplary credit preauthorization interaction on detection of a user device at a merchant according to an embodiment. FIG. 2 shows application interfaces and server application data corresponding generally a software interface of a check-in application and credit preauthorization application, executable by one or more hardware processors, for providing a credit preauthorization to a user on detection of a user device. Thus, user device interface 210, merchant device interface 230, and payment provider server 260 may correspond generally to user device 110, merchant device 130, and payment provider server 160 of FIG. 1.

User device interface 210 includes check-in application 220 having check-in status 222 and messages 224. Check-in application 220 may correspond generally to check-in application 120 of FIG. 1. Thus, check-in application 220 may enable a user to identify the location of the user possessing a user device running check-in application 220. Check-in application 220 may do so through communication with a merchant device and/or over a network.

Check-in status 222 displays information to a user corresponding to the user's location. As shown in FIG. 2, check-in status 222 displays a physical address and a merchant store with which the user is checked-in, e.g. 1234 Apple St. and Merchant Store A. Check-in status 222 may be set based on received information from a merchant device and/or service provider or may be set by the user, for example, using user device sensors and/or a mapping program. Check-in status may change based on user actions, such as entering or leaving a geographic area corresponding to a merchant, activating or deactivating check-in application 220 and/or a corresponding user device, or other action. In various embodiments, check-in status may include additional location and/or status information, such as merchant information, nearby merchants, and other desired information.

Check-in application 220 further includes messages 224. Messages 224 may correspond generally to received messages corresponding to check-in application 220 and relevant to check-in status 222. Thus, messages 224 in FIG. 2 include a credit preauthorization amount and sale offers for Merchant Store A. Messages 224 may display the credit preauthorization amount received from a merchant device, including credit terms, source, and additional information. The credit preauthorization amount message may further include a method to accept the credit preauthorization amount, such as instructions, a button for initiating a software process, hyperlink, web address, or other acceptance method.

Thus, the credit preauthorization amount message in messages 224 may contain active or passive authorization of the credit preauthorization amount. An active authorization of the credit preauthorization amount may include a feedback loop corresponding to a method to accept the credit preauthorization amount, as previously discussed, and including acceptance using a user device, wristwatch, eyeglasses, or other device with appropriate computer hardware. Active authorization may further include motions, gestures, device communication through a near field communication (e.g. swiping the device by a cash register), vocal acceptance using a device microphone, or other form of user initiated active acceptance of credit preauthorization amount. Passive acceptance of the credit preauthorization amount may include acceptance without user action, where the credit preauthorization amount is utilized on purchase of service and/or merchandise.

Messages 224 may further include advertisements, coupons, sale offers, or other marketing relevant to check-in status 222, for example, marketing corresponding to Merchant Store A. Additionally, messages 224 may further include other information, such as nearby locations of family/friends, messages from salespersons at a merchant, or other desired information.

User device interface 210 is connected to merchant device interface 230 through short range communication and to payment provider server 260 over network 280. Merchant device interface 230 includes preauthorization application 240 and payment application 250. Preauthorization application 240 and payment application 250 may correspond generally to preauthorization application 140 and payment application 150 of FIG. 1, respectively. Additionally, merchant device interface 230 is further connected to payment provider server 260 over network 260.

Preauthorization application 240 includes credit preauthorizations 242 displaying credit preauthorization amounts to a merchant, salesperson, or other viewer of merchant device interface 240. Credit preauthorizations 242 include a name or other identifier of a user and a credit preauthorization amount. Additionally, based on the preauthorization amount, a merchant or salesperson may choose items, as shown in FIG. 2, to offer the user. The items may also be chosen based on user preferences, sales, or other information possessed by the merchant. Credit preauthorizations 242 include credit preauthorization amounts for two customers, User A and User B, of Merchant Store A, as well as selected products for the users.

Payment application 250 includes current sale 252 and payment method 254. Payment application 250 provides a convenient interface to permit a salesperson to select, review, and sell items to a user. Thus, payment application 250 displays a customer and corresponding items selected for purchase under current sale 252. Current sale 252 identifies the customer as User A based on an interaction with a user device of User A, through merchant/salesperson input, or other received information. Additionally, current sales 252 displays items selected for purchase by User A. The items may be selected for purchasing through an interaction between a user device of the customer and payment application 250 or by the customer bringing the items to a purchase location. As shown in FIG. 2, the user has selected one of the offered items in messages 224 as well as three other items located in the store.

Payment application 250 further includes payment method 254, which may correspond to a selected payment type by User A. As shown in FIG. 2, User A has selected to purchase current sale 252 using the credit preauthorization amount offered by a credit provided and communicated to User A by the merchant. User A may have already accepted the credit using a user device, or User A may accept the credit while purchasing the items. Thus, payment application 250 may include processes to accept the credit. Additionally, payment application 250 may include processes to receive payment for the items from the credit source after the credit is accepted. In other embodiments, payment method 254 may include cash, check, credit or debit card, or other payment method.

User device interface 210 and merchant device interface 230 are connected to payment provider server 260 over network 280. Payment provider server 260 includes credit application 270 having user credit information 272. Credit application 270 may correspond generally to credit application 170 of FIG. 1. User credit information 272 may correspond to user information, user account information, or other information necessary to effectuate an offer for credit to a user. As shown in FIG. 2, user credit information 272 includes a credit score and a credit offer amount for User A at Merchant Store A. In various embodiments, user credit information 272 may include additional information, such as asset/debt amounts, banking information, or other information desired by payment provider server 260 to extend an offer for credit.

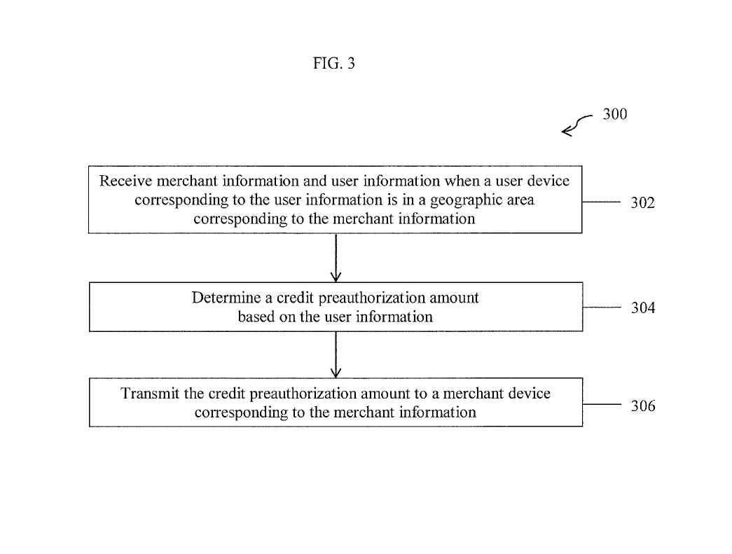

FIG. 3 is a flowchart of an exemplary process by a payment provider server for providing credit preauthorization on user device detection according to an embodiment. Note that one or more steps, processes, and methods described herein may be omitted, performed in a different sequence, or combined as desired or appropriate.

At step 302, a server, such payment provider server 160/260, receives merchant information and user information when a user device corresponding to the user information is in a geographic area corresponding to the merchant information. The geographic area may correspond to a retail merchant store, a short range wireless communication range with merchant device 130, or other geographic area corresponding to a merchant. The short range wireless communication may correspond to near field communication, radio communication, infrared communication, Bluetooth communication, Bluetooth low energy communication, or other wireless communication. The user device may be determined to be in the geographic area of the merchant through a check-in application operating over network 180 and/or with merchant device 130.

For example, payment provider server 160/260 may receive merchant information and user information when a user possessing a user device walks into a merchant location. As previously discussed, the server may receive the merchant information and/or user information from the merchant, such as merchant device 130, from the user, such as user 102 through user device 110, or from both. For example, user device 110 may utilize check-in application 120/220 with a credit provider, such as payment provider server 160, or with another online service that transmits user information and merchant information to the credit provider. However, in other embodiments, merchant device 130 may receive user information from user device 110 over short range wireless communication, and transmit the user information with merchant information to the credit provider.

User information may correspond to user personal information, a user account identifier, and a user device identifier. The user information may include information necessary to identify user 102 and determine a credit amount to extend to user 102. Merchant information may correspond to information identifying the merchant, such as a name, physical address, IP address, email, hardware identifier, account identifier, or other identifier. The merchant information may be utilized to determine a merchant the user is located at and respond to the merchant with a credit preauthorization amount.

Once the merchant information and user information is received, a credit preauthorization amount is determined based on the user information at step 304. The credit preauthorization amount may be determined based on the user's credit score/rating, assets/debts, purchase history and payments in general and/or with the specific merchant, recent purchase history and payments, expected income or debits, or other relevant financial data. For example, if the user frequently shops with the merchant and has never been late with payments, the user may be extended a larger preauthorization credit than with another merchant. In contrast, if the user has been late with payments, has made a lot of recent purchases, and is expected to incur upcoming debts (e.g., mortgage/rent payment, etc.), then the user may be extended a low or zero credit. The credit preauthorization may be further based on knowledge of the users current and/or future assets, such as income, one time payments (e.g. a tax refund), real estate/investment assets, or other current or potential asset. For example, the user may expect a one-time tax refund of $500 in the next week, and thus be extended a credit preauthorization amount considering this payment.

The credit preauthorization amount may be, in some embodiments, further based on the merchant information, such as name or type of merchant. For example, credit application 170/270 may look up user information and make a determination of an amount of credit to extend to the user. Credit application 170/270 may also utilize knowledge of store policies, store sale items and costs, or other merchant information. The credit preauthorization amount may include options and/or features such as revolving credit (e.g. a bill me later option). The merchant may also provide information to enable merchant specific credit to be added. For example, the merchant may offer store credit of $100 for users shopping on a certain day, time, or period.

At step 306, the credit preauthorization amount is transmitted to a merchant device that corresponds to the merchant information. Merchant device 130 may receive the credit preauthorization amount for payment provider server 160/260 and extend that amount (or a lesser or higher amount) to user 102 through user device 110. Thus, messages 224 of check-in application 120/220 may become populated with a credit preauthorization amount. Additionally, the merchant may transmit messages to user device 110 with the preauthorization amount, such as advertisements, coupons, sale offers, or other marketing. With knowledge of a specific user's credit amount, the merchant may target that user for specific service (such as by floor salespersons) or specific electronic incentives sent to the user device.

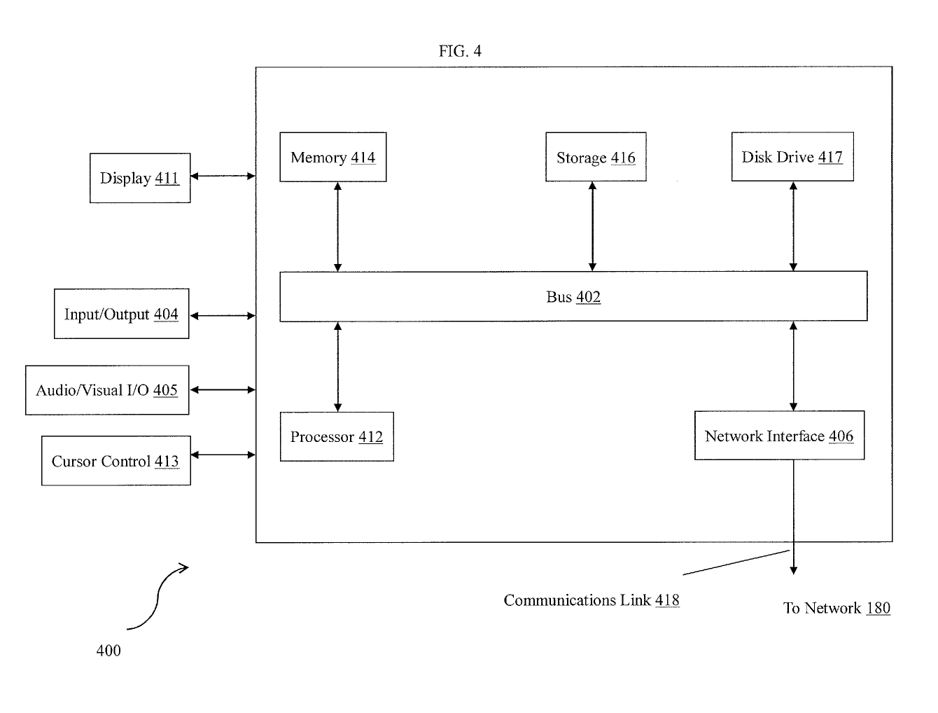

FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 180. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims

What is claimed is:

1. A system comprising:
a non-transitory memory storing user account information, wherein the user account information comprises user financial information; and
one or more hardware processors in communication with the non-transitory memory and configured to:
receive merchant information and user information, wherein the user information is received after a user device corresponding to the user information is determined to be in a geographic area corresponding to the merchant information;
determine a credit preauthorization amount based on the user information; and
transmit the credit preauthorization amount to a merchant device corresponding to the merchant information.

2. The system of claim 1, wherein the user information is one of user personal information, a user account identifier, and a user device identifier.

3. The system of claim 1, wherein the user device is determined to be in the geographic area corresponding to the merchant information using a check-in application.

4. The system of claim 1, wherein the user device is determined to be in the geographic area corresponding to the merchant information using a wireless connection with the merchant.

5. The system of claim 4, wherein the wireless connection is one of near field communication, radio communication, infrared communication, Bluetooth communication, and Bluetooth low energy communication.

6. The system of claim 1, wherein the merchant device is configured to transmit purchase recommendations corresponding to the credit preauthorization amount to the user device.

7. The system of claim 6, wherein the purchase recommendations include an item for sale at a merchant.

8. The system of claim 1, wherein the geographic area includes a retail store.

9. The system of claim 1, wherein the credit preauthorization amount includes a revolving credit option.

10. A method comprising:
receiving merchant information and user information, wherein the user information is received after a user device corresponding to the user information is determined to be in a geographic area corresponding to the merchant information;
determining, using a hardware processor of a payment provider server, a credit preauthorization amount based on the user information; and
transmitting the credit preauthorization amount to a merchant device corresponding to the merchant information.

11. The method of 10, wherein the user device is determined to be in the geographic area corresponding to the merchant information using a check-in application.

12. The method of claim 10, wherein the user device is determined to be in the geographic area corresponding to the merchant information using a wireless connection with the merchant.

13. The method of claim 12, wherein the wireless connection is one of near field communication, radio communication, infrared communication, Bluetooth communication, and Bluetooth low energy communication.

14. The method of claim 10, wherein the merchant device is configured to transmit purchase recommendations corresponding to the credit preauthorization amount to the user device.

15. The method of claim 10, wherein the credit preauthorization amount includes a revolving credit option.

16. A non-transitory computer readable medium comprising a plurality of machine-readable instructions which when executed by one or more processors of a server are adapted to cause the server to perform a method comprising:
receiving merchant information and user information, wherein the user information is received after a user device corresponding to the user information is determined to be in a geographic area corresponding to the merchant information;
determining a credit preauthorization amount based on the user information; and
transmitting the credit preauthorization amount to a merchant device corresponding to the merchant information.

17. The non-transitory computer readable medium of claim 16, wherein the user device is determined to be in the geographic area corresponding to the merchant information using a check-in application.

18. The non-transitory computer readable medium of claim 16, wherein the user device is determined to be in the geographic area corresponding to the merchant information using a wireless connection with the merchant.

19. The non-transitory computer readable medium of claim 18, wherein the wireless connection is one of near field communication, radio communication, infrared communication, Bluetooth communication, and Bluetooth low energy communication.

20. The non-transitory computer readable medium of claim 16, wherein the merchant device is configured to transmit purchase recommendations corresponding to the credit preauthorization amount to the user device.
